(19) United States
(12) Patent Application Publication
(10) Pub. No.: US 2012/0069028 A1
(43) Pub. Date: Mar. 22, 2012

(54) REAL-TIME ANIMATIONS OF EMOTICONS USING FACIAL RECOGNITION DURING A VIDEO CHAT

(75) Inventor: Bassem Bouguerra, San Francisco, CA (US)

(73) Assignee: YAHOO! INC., Sunnyvale, CA (US)

(21) Appl. No.: 12/886,482

(22) Filed: Sep. 20, 2010

(51) Int. Cl. G06T 15/70; G06F 3/048

(52) U.S. Cl. 345/473; 715/810

(57) ABSTRACT

Embodiments are directed towards displaying an animated video emoticon by augmenting features identified in a video stream. Augmenting features identified in the video stream may include modifying, in whole or in part, some aspects of the identified features but not other aspects. For example, a user may select an animated video emoticon indicating surprise. Surprise may be conveyed by detecting the location of the user's eyes in the video stream, enlarging a size aspect of the eyes so as to appear ‘wide-eyed’, but leaving other aspects such as color and shape unchanged. Then, the location and/or orientation of the eyes in the video stream are tracked, and the augmentation is applied to the eyes at each tracked location and/or orientation. In another embodiment, identified features may be removed from the video stream and replaced with images, graphics, video, and the like.

### TECHNICAL FIELD

The present invention relates generally to computer vision and real-time video effects, and more particularly, but not exclusively, to identifying features in a video stream for augmentation and/or replacement.

### BACKGROUND

Instant messaging has become one of the most popular applications on the Internet. Instant messaging programs generally allow users to send and receive text-based messages. The messages are generated and displayed by an instant messaging client on each end and an instant messaging server may perform various functions to facilitate the transfer of messages.

Typically, instant messaging programs enable ‘emoticons’ to be transmitted between instant messaging clients. Traditionally, emoticons have been defined as sequences of characters, typically appearing inline with text, used to convey emotion. Examples of traditional emoticons include: :-( (frown); -o (wow); :-x kiss); and ;-) (wink).

With the proliferation of video capture devices, such as webcams, video chat has begun to augment and even replace traditional text-based instant messaging. Participants in a video chat are typically focused on the video stream of their chat buddy, and so traditional emoticons appearing in text-based chat may be overlooked, if text-based chat is available at all. Thus, there is a need to provide a mechanism to convey emotions in a video chat.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description, which is to be read in association with the accompanying drawings, wherein:

FIG. 1 is a system diagram of one embodiment of an environment in which the invention may be practiced;

FIG. 2 shows one embodiment of a video chat client device that may be included in a system implementing the invention;

FIG. 3 shows one embodiment of a video chat server device that may be included in a system implementing the invention;

FIG. 4 illustrates a logical flow generally showing one embodiment of an overview process for use in adding animated video emoticons to a video stream by augmenting features identified within the video stream;

FIG. 5A illustrates a non-limiting, non-exhaustive example of a video-chat session;

FIG. 5B illustrates a non-limiting, non-exhaustive example of a video-chat session including an animated video emoticon generated by augmenting features identified within a video stream of the video-chat session;

FIG. 5C illustrates a non-limiting, non-exhaustive example of a video-chat session including the animated video emoticon depicted in FIG. 5B after the user has rotated their head 45 degrees;

FIG. 6 illustrates a non-limiting, non-exhaustive example of a video-chat session including an animated video-emoticon in which features are being augmented;

FIG. 7A illustrates a non-limiting, non-exhaustive example of a video-chat session including an animated video emoticon in which features are removed and replaced with computer graphics; and

FIG. 7B illustrates a non-limiting, non-exhaustive example of a video-chat session including an animated video emoticon in which images are being overlaid on top of a user's features.

### DETAILED DESCRIPTION

The present invention now will be described more fully hereinafter with reference to the accompanying drawings, which form a part hereof, and which show, by way of illustration, specific embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

Throughout the specification and claims, the following terms take the meanings explicitly associated herein, unless the context clearly dictates otherwise. The phrase “in one embodiment” as used herein does not necessarily refer to the same embodiment, though it may. Furthermore, the phrase “in another embodiment” as used herein does not necessarily refer to a different embodiment, although it may. Thus, as described below, various embodiments of the invention may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

Throughout the specification and claims, the term “animated video emoticon” refers to a modification of a video stream. Types of modifications include: 1) augmentation of features identified in the video stream, 2) removal and replacement of such identified features with a graphic (2D or 3D), image, and/or video, or 3) overlay of a graphic (2D or 3D), image, and/or video on top of the video stream based on the location of the identified features. Thus, as an animated video emoticon modifies a video stream, an animated video emoticon is considered to be distinct from traditional emoticons that appear in text and which are not based on features identified in a video stream.

Throughout the specification and claims, the phrase “augmentation of an aspect of a feature identified in a video stream”, refers to a modification of the video stream such that some aspect of the identified feature is altered, in part or in whole, while another aspect of the identified feature appears in the modified video. Examples of augmenting a feature include, in whole or in part, enlarging, shrinking, deforming, projecting, displacing, reflecting, scaling, rotating, mapping onto a surface (texture mapping), changing colors, anti-aliasing, or the like.

Throughout the specification and claims, “removal and replacement” of identified features refers to removing an identified feature from a video stream, replacing the removed feature by interpolating the surrounding background, and overlaying or otherwise adding a graphic (2D or 3D), image, or video onto at least some portion of a location from which the feature was removed.

The following briefly describes the embodiments of the invention in order to provide a basic understanding of some aspects of the invention. This brief description is not intended as an extensive overview. It is not intended to identify key or critical elements, or to delineate or otherwise narrow the scope. Its purpose is merely to present some concepts in a simplified form as a prelude to the more detailed description that is presented later.

Briefly stated the present invention is directed towards displaying an animated video emoticon by augmenting features identified in a video stream. Augmenting at least one feature identified in the video stream may include modifying, in whole or in part, some aspects of the identified feature. For example, a user may select an animated video emoticon indicating surprise. Surprise may be conveyed by detecting the location of the user's eyes in the video stream, enlarging a size aspect of the eyes so as to appear ‘wide-eyed’, but leaving other aspects such as color and shape unchanged. Then, the location and/or orientation of the eyes in the video stream are tracked, and the augmentation is applied to the eyes at each tracked location and/or orientation. In another embodiment, identified features may be removed from the video stream and replaced with images, graphics, video, or the like.

### Illustrative Operating Environment

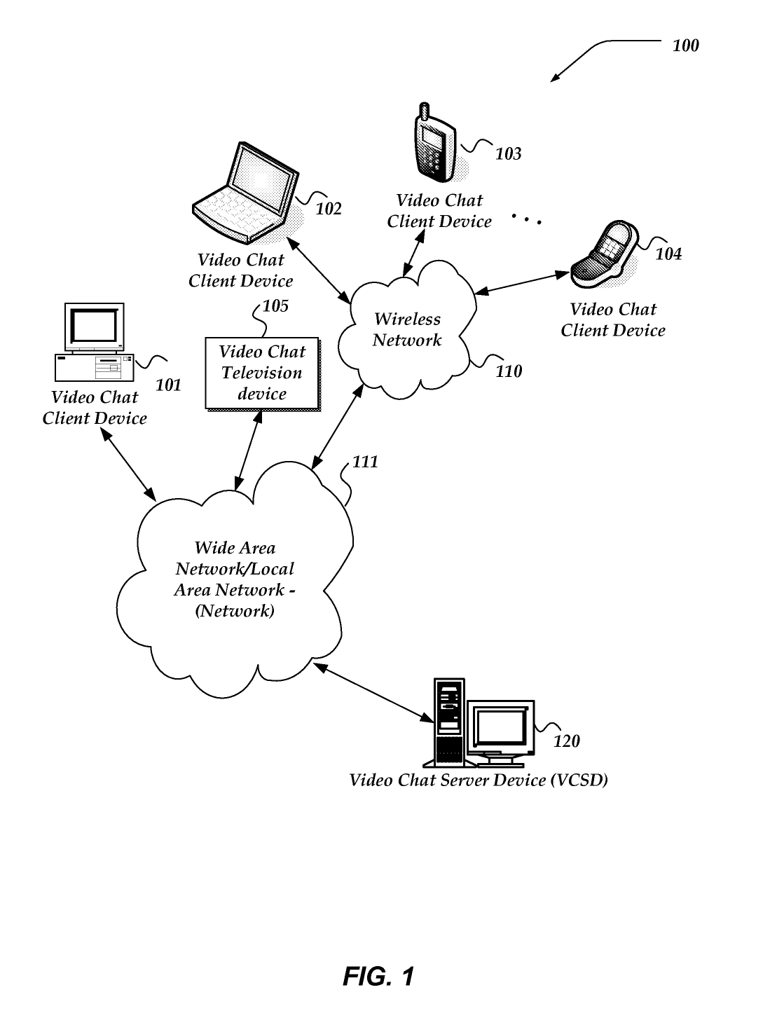

FIG. 1 shows components of one embodiment of an environment in which the invention may be practiced. Not all the components may be required to practice the invention, and variations in the arrangement and type of the components may be made without departing from the spirit or scope of the invention. As shown, system 100 of FIG. 1 includes local area networks (“LANs”)/wide area networks (“WANs”)—(network) 111, wireless network 110, video chat client devices 101-105, and video chat server device 120.

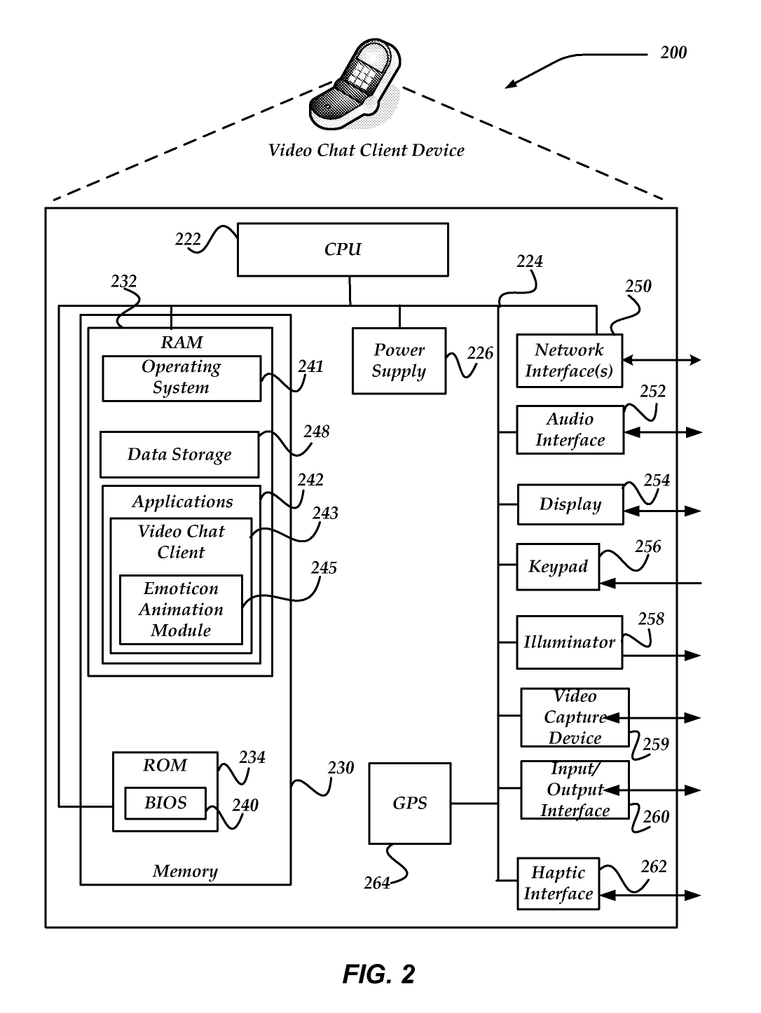

One embodiment of video chat client devices 101-105 is described in more detail below in conjunction with FIG. 2. Generally, however, video chat client devices 102-104 may include virtually any portable computing device capable of receiving and sending a message over a network, such as network 111, wireless network 110, or the like. Video chat client devices 102-104 may also be described generally as client devices that are configured to be portable. Thus, video chat client devices 102-104 may include virtually any portable computing device capable of connecting to another computing device and receiving information. Such devices include portable devices such as, cellular telephones, smart phones, display pagers, radio frequency (RF) devices, infrared (IR) devices, Personal Digital Assistants (PDAs), handheld computers, laptop computers, wearable computers, tablet computers, integrated devices combining one or more of the preceding devices, and the like. As such, video chat client devices 102-104 typically range widely in terms of capabilities and features. For example, a cell phone may have a numeric keypad and a few lines of monochrome LCD display on which only text may be displayed. In another example, a web-enabled mobile device may have a touch sensitive screen, a stylus, and several lines of color LCD display in which both text and graphics may be displayed.

Video chat client device 101 may include virtually any computing device capable of communicating over a network to send and receive information, including social networking information, performing various online activities, or the like. The set of such devices may include devices that typically connect using a wired or wireless communications medium such as personal computers, multiprocessor systems, microprocessor-based or programmable consumer electronics, network PCs, or the like. In one embodiment, at least some of video chat client devices 102-104 may operate over wired and/or wireless network. Video chat client device 105 may include virtually any device useable as a television device. Today, many of these devices include a capability to access and/or otherwise communicate over a network such as network 111 and/or even wireless network 110. Moreover, video chat client device 105 may access various computing applications, including a browser, or other web-based application.

A web-enabled video chat client device may include a browser application that is configured to receive and to send web pages, web-based messages, and the like. The browser application may be configured to receive and display graphics, text, multimedia, and the like, employing virtually any web-based language, including a wireless application protocol messages (WAP), and the like. In one embodiment, the browser application is enabled to employ Handheld Device Markup Language (HDML), Wireless Markup Language (WML), WMLScript, JavaScript, Standard Generalized Markup Language (SMGL), HyperText Markup Language (HTML), eXtensible Markup Language (XML), and the like, to display and send a message. In one embodiment, a user of the video chat client device may employ the browser application to perform various activities over a network (online). However, another application may also be used to perform various online activities.

Video chat client devices 101-105 are typically configured to include a video capture device, such as a Webcam, with which to receive audio/video input for the purpose of video chatting. Video chat client devices 101-105 also are typically configured with a mouse, keyboard, touch-screen, keypad, or other human input device enabling a user to select an animated video emoticon.

Wireless network 110 is configured to couple video chat client devices 102-104 and its components with network 111. Wireless network 110 may include any of a variety of wireless sub-networks that may further overlay stand-alone ad-hoc networks, and the like, to provide an infrastructure-oriented connection for video chat client devices 102-104. Such sub-networks may include mesh networks, Wireless LAN (WLAN) networks, cellular networks, and the like.

Wireless network 110 may further include an autonomous system of terminals, gateways, routers, and the like connected by wireless radio links, and the like. These connectors may be configured to move freely and randomly and organize themselves arbitrarily, such that the topology of wireless network 110 may change rapidly.

Wireless network 110 may further employ a plurality of access technologies including 2nd (2G), 3rd (3G) generation radio access for cellular systems, WLAN, Wireless Router (WR) mesh, and the like. Access technologies such as 2G, 3G, and future access networks may enable wide area coverage for mobile devices, such as video chat client devices 102-104 with various degrees of mobility. For example, wireless network 110 may enable a radio connection through a radio network access such as Global System for Mobil communication (GSM), General Packet Radio Services (GPRS), Enhanced Data GSM Environment (EDGE), Wideband Code Division Multiple Access (WCDMA), and the like. In essence, wireless network 110 may include virtually any wireless communication mechanism by which information may travel between video chat client devices 102-104 and another computing device, network, and the like.

Network 111 is configured to couple network devices with other computing devices, including, video chat server device 120, client devices 101 and 105, and through wireless network 110 to client devices 102-104. Network 111 is enabled to employ any form of computer readable media for communicating information from one electronic device to another. Also, network 111 can include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another. In addition, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, remote computers and other related electronic devices could be remotely connected to either LANs or WANs via a modem and temporary telephone link. In essence, network 111 includes any communication method by which information may travel between computing devices.

Additionally, communication media typically provides a transport mechanism for computer-readable instructions, data structures, program modules, or other information. By way of example, communication media includes wired media such as twisted pair, coaxial cable, fiber optics, wave guides, and other wired media and wireless media such as acoustic, RF, infrared, and other wireless media.

Video chat server device (VCSD) 120 includes virtually any network device usable to operate as website servers to provide content to client devices 101-105. Additionally or alternatively, VCSD 120 may include a server farm, cluster, cloud, or other arrangement of servers individually or collectively performing the function of VCSD 120. Such content may include, but is not limited to webpage content, advertisements, professionally generated content, search results, blogs, and/or photograph sharing pages for access by another client device. Video chat server device 120 may also operate as a messaging server such as an SMS message service, IM message service, email message service, alert service, or the like. Moreover, video chat server device 120 may also operate as a File Transfer Protocol (FTP) server, a database server, music and/or video download server, or the like. Additionally, video chat server device 120 may be configured to perform multiple functions.

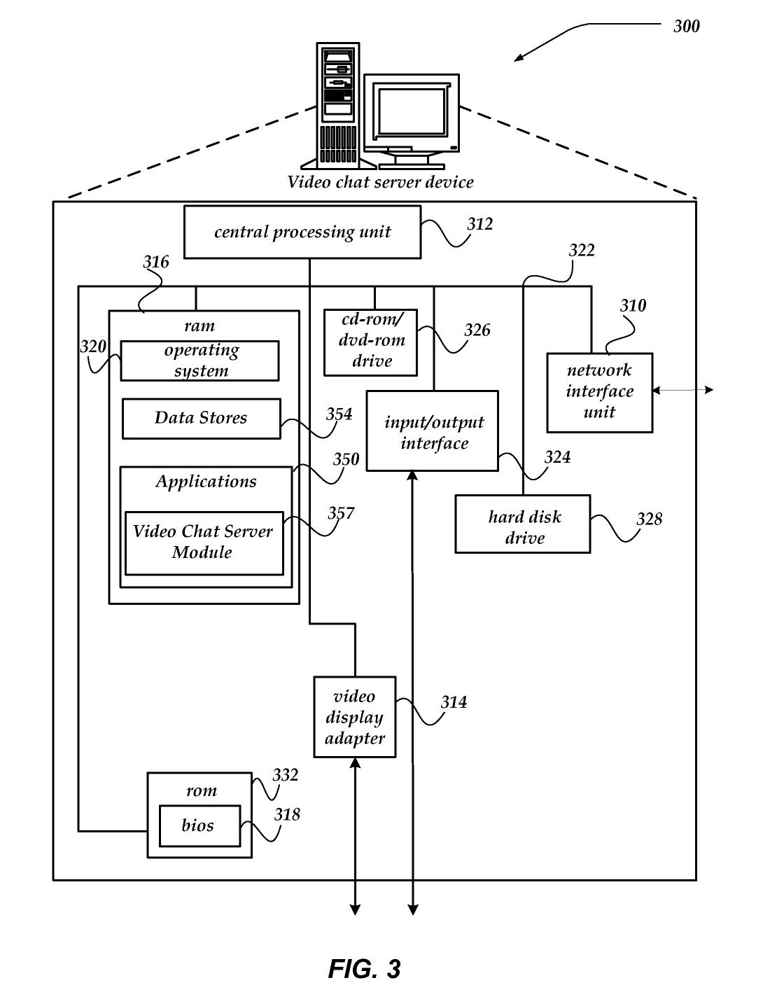

Video chat server device 120 is also configured to receive instant messages and video-chat video streams. Video chat server device 120 may then transfer to one or more of video chat client devices 101-105 the received instant messages and video-chat streams. However, virtually any video stream may have an animated video emoticon inserted into it by augmenting features of that video stream. One embodiment of a network device usable as video chat server device 120 is described in more detail below in conjunction with FIG. 3.

Devices that may operate as video chat server device 120 include various network devices, including, but not limited to personal computers, desktop computers, multiprocessor systems, microprocessor-based or programmable consumer electronics, network PCs, server devices, network appliances, and the like.

### Illustrative Video Chat Client Device

FIG. 2 shows one embodiment of video chat client device 200 that may be included in a system implementing the invention. Video chat client device 200 may include many more or less components than those shown in FIG. 2. However, the components shown are sufficient to disclose an illustrative embodiment for practicing the present invention. Video chat client device 200 may represent, for example, one embodiment of at least one of video chat client devices 101-105 of FIG. 1.

As shown in the figure, video chat client device 200 includes a central processing unit (CPU) 222 in communication with a mass memory 230 via a bus 224. Video chat client device 200 also includes a power supply 226, one or more network interfaces 250, an audio interface 252, a display 254, a keypad 256, an illuminator 258, a video capture device 259, an input/output interface 260, a haptic interface 262, and an optional global positioning systems (GPS) receiver 264. Power supply 226 provides power to video chat client device 200. A rechargeable or non-rechargeable battery may be used to provide power. The power may also be provided by an external power source, such as an AC adapter or a powered docking cradle that supplements and/or recharges a battery.

Video chat client device 200 may optionally communicate with a base station (not shown), or directly with another computing device. Network interface 250 includes circuitry for coupling video chat client device 200 to one or more networks, and is constructed for use with one or more communication protocols and technologies including, but not limited to, global system for mobile communication (GSM), code division multiple access (CDMA), time division multiple access (TDMA), user datagram protocol (UDP), transmission control protocol/Internet protocol (TCP/IP), SMS, general packet radio service (GPRS), WAP, ultra wide band (UWB), IEEE 802.16 Worldwide Interoperability for Microwave Access (WiMax), SIP/RTP, or any of a variety of other wireless communication protocols. Network interface 250 is sometimes known as a transceiver, transceiving device, or network interface card (NIC).

Audio interface 252 is arranged to produce and receive audio signals such as the sound of a human voice. For example, audio interface 252 may be coupled to a speaker and microphone (not shown) to enable telecommunication with others and/or generate an audio acknowledgement for some action. Display 254 may be a liquid crystal display (LCD), gas plasma, light emitting diode (LED), or any other type of display used with a computing device. Display 254 may also include a touch sensitive screen arranged to receive input from an object such as a stylus or a digit from a human hand.

Keypad 256 may comprise any input device arranged to receive input from a user. For example, keypad 256 may include a push button numeric dial, or a keyboard. Keypad 256 may also include command buttons that are associated with selecting and sending images. Illuminator 258 may provide a status indication and/or provide light. Illuminator 258 may remain active for specific periods of time or in response to events. For example, when illuminator 258 is active, it may backlight the buttons on keypad 256 and stay on while the client device is powered. Also, illuminator 258 may backlight these buttons in various patterns when particular actions are performed, such as dialing another client device. Illuminator 258 may also cause light sources positioned within a transparent or translucent case of the client device to illuminate in response to actions.

Video capture device 259 may comprise any camera capable of recording video. Video capture device 259 may include a Webcam, a camcorder, a digital camera, or the like.

Video chat client device 200 also comprises input/output interface 260 for communicating with external devices, such as a headset, or other input or output devices not shown in FIG. 2. Input/output interface 260 can utilize one or more communication technologies, such as USB, infrared, Bluetooth™, or the like. Haptic interface 262 is arranged to provide tactile feedback to a user of the client device. For example, the haptic interface may be employed to vibrate video chat client device 200 in a particular way when another user of a computing device is calling.

Optional GPS transceiver 264 can determine the physical coordinates of video chat client device 200 on the surface of the Earth, which typically outputs a location as latitude and longitude values. GPS transceiver 264 can also employ other geo-positioning mechanisms, including, but not limited to, triangulation, assisted GPS (AGPS), E-OTD, CI, SAI, ETA, BSS or the like, to further determine the physical location of video chat client device 200 on the surface of the Earth. It is understood that under different conditions, GPS transceiver 264 can determine a physical location within millimeters for video chat client device 200; and in other cases, the determined physical location may be less precise, such as within a meter or significantly greater distances. In one embodiment, however, mobile device may through other components, provide other information that may be employed to determine a physical location of the device, including for example, a MAC address, IP address, or the like.

Mass memory 230 includes a RAM 232, a ROM 234, and other non-transitory storage means. Mass memory 230 illustrates an example of computer readable storage media (devices) for storage of information such as computer readable instructions, data structures, program modules or other data. Mass memory 230 stores a basic input/output system (“BIOS”) 240 for controlling low-level operation of video chat client device 200. The mass memory also stores an operating system 241 for controlling the operation of video chat client device 200. It will be appreciated that this component may include a general-purpose operating system such as a version of UNIX, or LINUX™, or a specialized client communication operating system such as Windows Mobile™, or the Symbian® operating system. The operating system may include, or interface with a Java virtual machine module that enables control of hardware components and/or operating system operations via Java application programs.

Applications 242 may include computer executable instructions which, when executed by video chat client device 200, transmit, receive, and/or otherwise process messages (e.g., SMS, MMS, IM, email, and/or other messages), audio, video, and enable telecommunication with another user of another client device. Other examples of application programs include calendars, search programs, email clients, IM applications, SMS applications, VOIP applications, contact managers, task managers, transcoders, database programs, word processing programs, security applications, spreadsheet programs, games, search programs, and so forth. Applications 242 may include, for example, video chat client 243.

Video chat client 243 may be configured to manage a messaging session using any of a variety of messaging communications including, but not limited to email, Short Message Service (SMS), Instant Message (IM), Multimedia Message Service (MMS), internet relay chat (IRC), mIRC, RSS feeds, and/or the like. For example, in one embodiment, video chat client 243 may be configured as an IM application, such as AOL Instant Messenger, Yahoo! Messenger, .NET Messenger Server, ICQ, or the like. As used herein, the term “message” refers to any of a variety of messaging formats, or communications forms, including but not limited to email, SMS, IM, MMS, IRC, or the like.

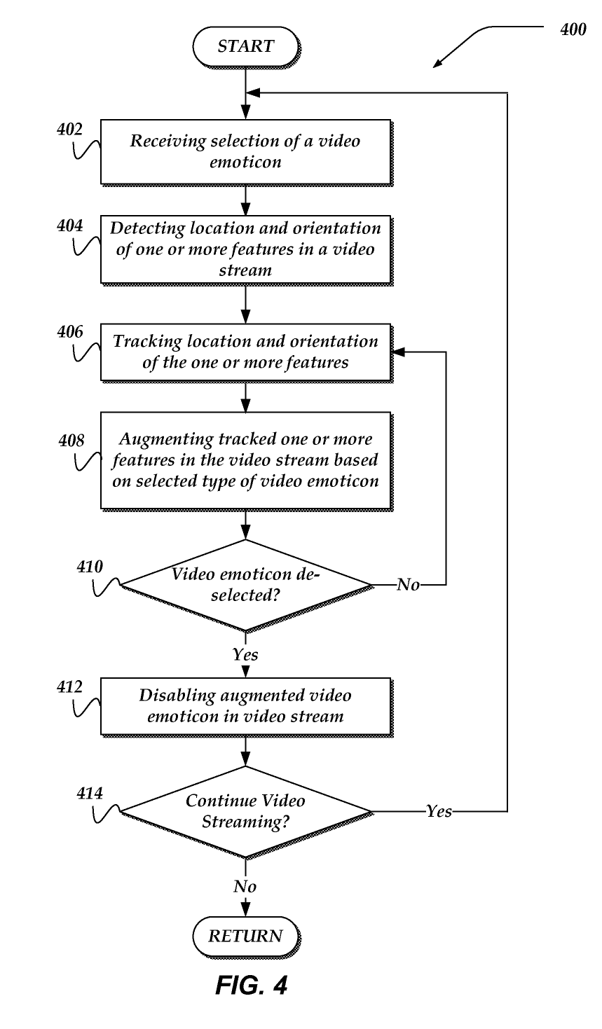

In one embodiment, video chat client 243 may support video-chat sessions, wherein a video of a user may be captured using video capture device 259 and streamed to another user for display with display 254. Additionally or alternatively, a video of the other user may be captured and streamed to video chat client device 200 for display with display 254. In one embodiment, video chat client 243 includes emoticon animation module 245. However, the invention is not so limited, and emoticon animation model 245 can also be separate from video chat client device 243, downloadable from a server, or even executed on a server. In one embodiment, emoticon animation module 245 receives a video stream and a selection of a video emoticon and generates the video emoticon in the video stream, as discussed in conjunction with FIG. 4 below.

Additionally or alternatively, during a setup phase, emoticon animation model 245 may solicit user cooperation to increase the accuracy with which features are identified. For example, video chat client 245 may prompt a user to look into video capture device 259 without moving, enabling video chat client 245 to more accurately identify features of the user. In one embodiment, video chat client 245 may request the user position their face and/or body at different angles to the camera, in order to more accurately identify features on the user from these angles. In one embodiment, video chat client 245 may prompt the user to confirm the accuracy of features identified in the setup phase by displaying still images of the user with identified features highlighted, and enabling the user to confirm the accuracy of the identified features.

In one embodiment, video chat client 243 stores one or more animated video emoticons, for example in data storage 248, a hard drive, or the like. In one embodiment, each of the stored animated video emoticons is selectable by the user to apply to the video stream. In one embodiment, multiple emoticons may be selected by the user for display at the same time. In one embodiment a user may download additional animated video emoticons from a centralized server, or transfer animated video emoticons to and from friends.

### Illustrative Network Device

FIG. 3 shows one embodiment of a network device 300, according to one embodiment of the invention. Network device 300 may include many more or less components than those shown. The components shown, however, are sufficient to disclose an illustrative embodiment for practicing the invention. Network device 300 may represent, for example, video chat server device 120.

Network device 300 includes processing unit 312, video display adapter 314, and a mass memory, all in communication with each other via bus 322. The mass memory generally includes RAM 316, ROM 332, and one or more permanent mass storage devices, such as hard disk drive 328, tape drive, optical drive, and/or floppy disk drive. The mass memory stores operating system 320 for controlling the operation of network device 300. Any general-purpose operating system may be employed. Basic input/output system (“BIOS”) 318 is also provided for controlling the low-level operation of network device 300. As illustrated in FIG. 3, network device 300 also can communicate with the Internet, or some other communications network, via network interface unit 310, which is constructed for use with various communication protocols including the TCP/IP protocol. Network interface unit 310 is sometimes known as a transceiver, transceiving device, or network interface card (NIC).

The mass memory as described above illustrates another type of computer-readable media, namely computer-readable storage media. Computer-readable storage media (devices) may include volatile, nonvolatile, removable, and non-removable media implemented in any method or technology for storage of information, such as computer readable instructions, data structures, program modules, or other data. Examples of computer readable storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other physical medium which can be used to store the desired information and which can be accessed by a computing device.

As shown, data stores 354 may include a database, text, spreadsheet, folder, file, or the like, that may be configured to maintain and buddy lists, video-emoticon graphics, per-user video-emoticon preferences, and the like. Data stores 354 may further include program code, data, algorithms, and the like, for use by a processor, such as central processing unit (CPU) 312 to execute and perform actions. In one embodiment, at least some of data store 354 might also be stored on another component of network device 300, including, but not limited to cd-rom/dvd-rom 326, hard disk drive 328, or the like.

The mass memory also stores program code and data. One or more applications 350 are loaded into mass memory and run on operating system 320. Examples of application programs may include transcoders, schedulers, calendars, database programs, word processing programs, HTTP programs, customizable user interface programs, IPSec applications, encryption programs, security programs, SMS message servers, IM message servers, email servers, account managers, and so forth. Video chat server module 357 may also be included within applications 350.

Video chat server module 357 may represent any of a variety of services that are configured to provide content, including messages and/or video streams, over a network to another computing device. In one embodiment, video chat server module 357 may also store one or more animated video emoticons for download by video chat client device 200. The animated video emoticons may be stored in data store 354, cd-rom/dvd-rom drive 326, hard disk drive 328, or the like.

In one embodiment, video chat server module 357 may operate as a conduit for video streams communicated between two client devices engaged in a video chat. In one embodiment, video chat server module 357 may, using the techniques discussed herein, generate video emoticons in these video streams by augmenting features identified in the video streams. In one embodiment, video chat server 300 and one or more of video chat client devices 200 engaged in a video chat may generate video emoticons in the same video stream.

### Generalized Operation

The operation of certain aspects of the invention will now be described with respect to FIG. 4. FIG. 4 illustrates a logical flow generally showing one embodiment of an overview process for use in adding animated video emoticons to a video stream by augmenting features identified within the video stream. In one embodiment process 400 of FIG. 4 may be performed by video chat client device 200.

Process 400 begins, after a start block, at block 402, where a selection of an animated video emoticon is received from a user. For example, the user may select a video emoticon that conveys surprise, although any emotion or concept to be conveyed is similarly contemplated. Each video emoticon is associated with a predefined set of features. In the case of a ‘surprise’ video emoticon, the predefined features may include a pair of eyes. However, other features are similarly contemplated, including a nose, ears, mouth, chin, teeth, neck, hair, torso, arms, legs, hand, fingers, thumb, and/or wrist. In addition to body parts, features such as a dog's face, a vacuum cleaner, a car, or virtually any other object is similarly contemplated.

The video emoticon may be selected from a menu, or a video emoticon may be selected through text input. For example, a ‘smiley’ video emoticon may be selected by typing “:-)” into a chat window associated with the video-chat. Additionally or alternatively, a video emoticon may be selected from a graphical interface or even perceived from a video stream. Video emoticons may be stored locally on a video chat client device, or alternatively be stored on a video chat server device.

Additionally or alternatively, a video emoticon may be invoked based on an analysis of the video stream. In one embodiment, the video-chat application may be set to an “augmented reality” mode during which patterns of features in the video stream are dynamically inferred using, for example, machine vision learning techniques. In one embodiment, a library such as the openCV computer vision library may be used to identify features in a video stream in real-time. For example, in augmented reality mode, the detection of a smile by the user may cause the ‘smiley’ video emoticon to be automatically invoked, without user input, thereby augmenting the emotion conveyed by the user. If the user subsequently begins to frown, this frown will be detected and a ‘frowning’ video emoticon will be selected.

In one embodiment, the selection of an animated video emoticon persists until de-selection by the user. Alternatively, an animated video emoticon may persist for a set period of time after which the animated video emoticon terminates without user input.

In one embodiment, when a user of a client device selects an animated video emoticon, the animated video emoticon is applied to the video captured by the first client device before it is transmitted to another client device. However, the user of the client device may additionally or alternatively select to apply an animated video emoticon to a video stream received from the other client device. For example, a first friend may want to see what his video-chat buddy would look like ‘surprised’, and so the first friend may invoke the ‘surprised’ video emoticon on the video stream depicting his buddy.

Flowing next to block 404, the location of one or more features associated with the selected animated video emoticon is detected within the video stream. In one embodiment, the one or more features are detected in a frame of the video stream, however it is similarly contemplated that two or more frames may be analyzed to identify the location of a feature. In one embodiment, the features to be detected are associated with the selected type of video emoticon. For example, the ‘surprised’ animated video emoticon may be associated with a pair of eyes, forehead, mouth, and/or other facial features. However, detecting features associated with the selected type of animated video emoticon may include detecting additional related features in order to increase the accuracy of feature detection and to detect the proper orientation of the features. For example, if an animated video emoticon is associated with a pair of eyes, feature detection may also identify a nose, a chin, a mouth, or any other recognizable feature to assist in detecting the proper orientation of the pair of eyes. In one embodiment, upon detecting the location of two eyes and another feature such as a mouth, a cross product may be used to identify the orientation of a face. In one embodiment, feature detection may be initialized during a setup phase, such as described above.

In one embodiment, features are identified using a bounding box. In one embodiment, when some features to be identified are contained within other features, such as eyes on a user's face, successive bounding boxes may be used to first identify the containing feature (e.g. face) and then to identify the contained feature (e.g. eye). In other embodiments, a single bounding box may be used to identify each distinct feature. In one embodiment, a library such as the openCV (http://opencv.willowgarage.com/wiki/) computer vision library may be used to identify these features and to generate bounding boxes. In one embodiment, the bounding box need not be rectangular (e.g. a box). For example, the bounding box may be elliptical. In one embodiment, a machine learning technique such as boosting may be used to increase a confidence level in a detection of a feature.

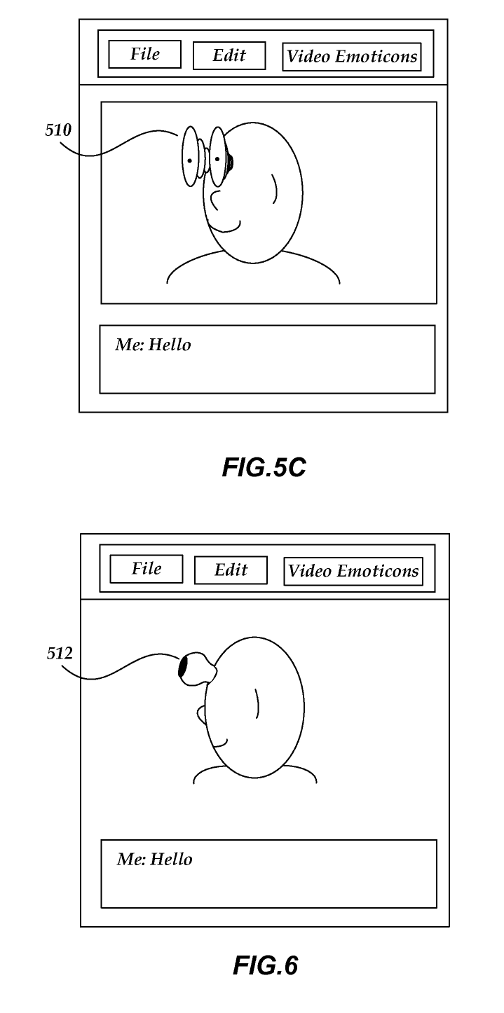

In one embodiment, a subset of the features associated with the selected animated video emoticon may not be visible. This could happen if the user rotates one of the features out of view of the video capture device, as depicted in FIG. 6. In one embodiment, the animated video emoticon module may determine the position and orientation of the feature that is out of view based on the position and orientation of other features that are in view. For example, if a user's eyes are measured at some distance apart, and the user's face is detected to rotate such that one eye is out of view, known or estimated distance between the eyes and the known or estimated orientation of the face may be used to calculate the position and orientation of the occluded or missing eye. In another embodiment, the feature that falls out of view is not augmented/replaced/modified.

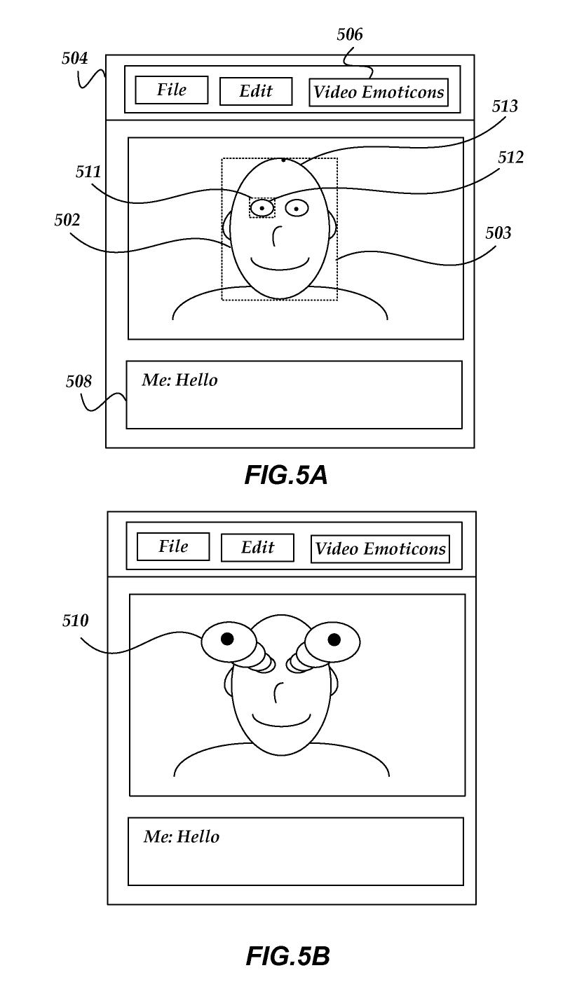

Flowing next to block 406, the location and orientation of the detected features are tracked. Features may be tracked as they are moved in any of the six degrees of freedom, including horizontally, vertically and/or as they are moved rotationally. Features may be tracked from frame to frame of the video stream. In one embodiment, features may be identified in each frame of the video stream, however it is also contemplated that features may be identified by analyzing two or more frames of the video stream. Accordingly, an animated video emoticon that employs a three-dimensional graphic over a user's eyes will rotate as the user rotates their head, as discussed below in conjunction with FIGS. 5B and 5C. In one embodiment, an optical flow algorithm may be used to optimize tracking of identified features.

Flowing next to block 408, the tracked features associated with the selected video emoticon are augmented. Non-limiting, non-exhaustive examples of augmenting a tracked feature include, in whole or in part, enlarging, shrinking, deforming, projecting, displacing, reflecting, scaling, rotating, mapping onto a surface (texture mapping), changing colors, anti-aliasing, or the like. For example, an eye may be made to bulge, as depicted in FIG. 6. Other examples include adding length to a person's hair, increasing the size of their bust, decreasing the size of their stomach, mapping their eyes onto the lenses of a pair of glasses, and the like.

Continuing to decision block 410, it is optionally determined whether the user has de-selected the animated video emoticon. If the user has de-selected the animated video emoticon, then the flow proceeds to block 412 where the animated video emoticon is disabled. Otherwise, if the user has not deselected the animated video emoticon, the process returns to block 406. Additionally or alternatively, the animated video emoticon may be automatically enabled/disabled, without user selection, as noted above.

At decision block 414, it is determined whether video streaming is to continue. In one embodiment, video streaming may end upon the request of a user engaged in video chat. If it is determined that streaming is to continue, then the flow proceeds to block 402. Otherwise, if it is determined that streaming is not to continue, then the process proceeds to a return block.

It will be understood that each block of the flowchart illustration, and combinations of blocks in the flowchart illustration, can be implemented by computer program instructions. These program instructions may be provided to a processor to produce a machine, such that the instructions, which execute on the processor, create means for implementing the actions specified in the flowchart block or blocks. The computer program instructions may be executed by a processor to cause a series of operational steps to be performed by the processor to produce a computer-implemented process such that the instructions, which execute on the processor to provide steps for implementing the actions specified in the flowchart block or blocks. The computer program instructions may also cause at least some of the operational steps shown in the blocks of the flowchart to be performed in parallel. Moreover, some of the steps may also be performed across more than one processor, such as might arise in a multi-processor computer system. In addition, one or more blocks or combinations of blocks in the flowchart illustration may also be performed concurrently with other blocks or combinations of blocks, or even in a different sequence than illustrated without departing from the scope or spirit of the invention.

Accordingly, blocks of the flowchart illustration support combinations of means for performing the specified actions, combinations of steps for performing the specified actions and program instruction means for performing the specified actions. It will also be understood that each block of the flowchart illustration, and combinations of blocks in the flowchart illustration, can be implemented by special purpose hardware-based systems, which perform the specified actions or steps, or combinations of special purpose hardware and computer instructions.

FIG. 5A illustrates a non-limiting, non-exhaustive example of a video-chat session. User 502 appears in video-chat session 504 on a client device of another user. The other user may optionally be viewing a similar video-chat session on his client device, although one-way video-chat sessions are contemplated. Bounding box 503 identifies the face 513 of user 502, while bounding box 511 identifies the right eye 512 of user 502. Video emoticons menu 506 may be used to select a video emoticon. Chat box 508 provides an alternative means for a user to select a video emoticon, as discussed above.

FIG. 5B illustrates a non-limiting, non-exhaustive example of a video-chat session including an animated video emoticon generated by augmenting features identified within a video stream of the video-chat session. Graphical augmentation 510 may include one or more images, 2D or 3D graphics, and/or video. In this example, graphical augmentation 510 is an animated graphic associated with the eyes of user 502. In one embodiment, eye 512 has been removed and replaced with graphical augmentation 510. In one embodiment, graphical augmentation can dynamically grow outwards to show surprise, shock, or other emotions.

FIG. 5C illustrates a non-limiting, non-exhaustive example of a video-chat session including the animated video emoticon depicted in FIG. 5B after the user has rotated their head 45 degrees. In one embodiment, graphical augmentation 510 moves with head movement. As is clear from the drawing, graphical augmentation 510 has been rotated in sync with rotation of user 502.

FIG. 6 illustrates a non-limiting, non-exhaustive example of a video-chat session including an animated video-emoticon in which features are being augmented. In one embodiment, this augmentation is a real-time modification of one aspect of the user's actual eyes. For example, if the user were to look to the left, the pupils of the corresponding augmented eyes would also ‘look to the left’.

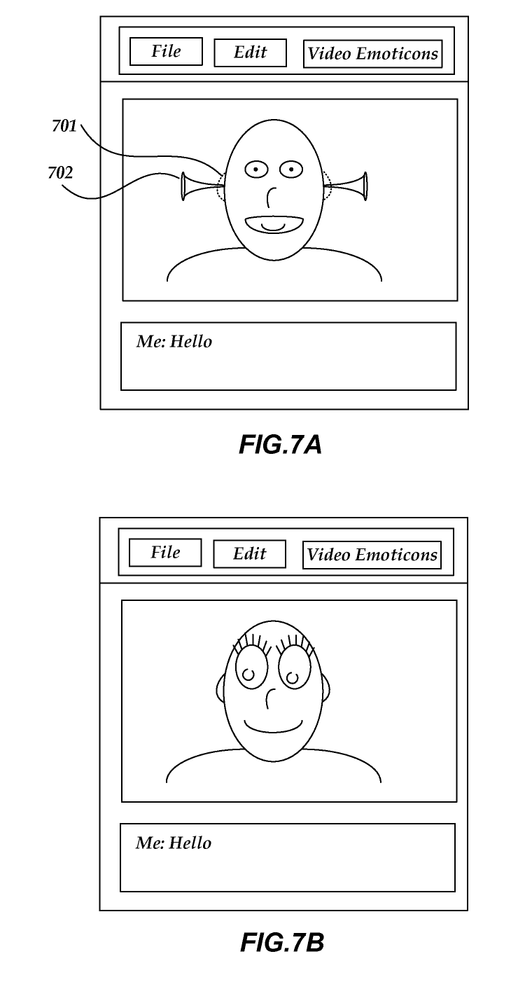

FIG. 7A illustrates a non-limiting, non-exhaustive example of a video-chat session including an animated video emoticon in which features are removed and replaced with computer graphics. As discussed above, the graphics replacing the ears 701 may be static or animated, they may include images, drawings, 2D or 3D graphics, or some combination thereof. As is clear from the drawing, the user's ears 701 have been replaced in part with a portion of the background and in part with horns 702.

In one embodiment, removal and replacement of features occurs when the actual background of the video stream has been digitally replaced with a computer-generated background. In this embodiment, features such as ears may be removed and replaced with portions of the computer-generated background image. However, scenarios without a digitally created background are also contemplated, such as by interpolating surrounding pixel colors to fill the area exposed by removing features.

FIG. 7B illustrates a non-limiting, non-exhaustive example of a video-chat session including an animated video emoticon in which images are being overlaid on top of a user's features.

The above specification, examples, and data provide a complete description of the manufacture and use of the composition of the invention. Since many embodiments of the invention can be made without departing from the spirit and scope of the invention, the invention resides in the claims hereinafter appended.

What is claimed as new and desired to be protected by Letters Patent of the United States is:

1. A client device, comprising:
a transceiver to send and receive data over a network; and
a processor that is operative on the received data to perform actions, including:
receiving a selection of an animated video emoticon, the animated video emoticon associated with a set of features within a video stream;
detecting a location of at least one feature in the set of features in a frame of the video stream;
tracking a change in location of the at least one feature across another frame of the video stream; and
augmenting at least one aspect of the at least one tracked feature in the other frame of the video stream.

2. The client device of claim 1, wherein augmenting includes removing the at least one tracked feature from the other frame and inserting a computer generated graphics content into the other frame at the location of the removed at least one tracked feature.

3. The client device of claim 1, wherein the animated video emoticon is selected by detecting a predefined set of features in the frame of the video stream.

4. The client device of claim 1, wherein the at least one feature is occluded in the other frame, and wherein detecting the location of the occluded at least one feature is based on a detected location of another feature that is visible in the other frame and a relative position of the at least one feature to the other feature.

5. The network device of claim 1, wherein the set of features include at least one of two eyes, a mouth, ears, a chin, or a nose.

6. The network device of claim 1, wherein tracking further comprises determining an orientation of the set of features based on the detected locations of the at least three features in the set of features.

7. The network device of claim 1, wherein tracking further comprises detecting the location of a feature that is occluded in the frame of the video but visible in the other frame of the video stream.

8. A system, comprising:
a computer-readable storage device storing instructions; and
a client device operable to execute the stored instructions to perform actions, comprising:
receiving a selection of an animated video emoticon, the animated video emoticon associated with a set of features within a video stream;
detecting a location of at least one feature in the set of features in a frame of the video stream;
tracking a change in location of the at least one feature across another frame of the video stream; and
augmenting at least one aspect of the at least one tracked feature in the other frame of the video stream.

9. The system of claim 8, wherein augmenting includes removing the at least one tracked feature from the other frame and inserting a computer generated graphics content into the other frame at the location of the removed at least one tracked feature.

10. The system of claim 8, wherein the animated video emoticon is selected by detecting patterns of text in a chat message.

11. The system of claim 8, wherein the at least one feature is occluded in the other frame, and wherein detecting the location of the occluded at least one feature is based on a detected location of another feature that is visible in the other frame and a relative position of the at least one feature to the other feature.

12. The system of claim 8, wherein the set of features include a leg, a torso, an arm, and a head.

13. The system of claim 8, wherein tracking further comprises determining an orientation of the set of features based on the detected locations of the at least three features in the set of features.

14. A computer-readable storage medium having computer-executable instructions, the computer-executable instructions when installed onto a computing device enable the computing device to perform actions, comprising:
receiving a selection of an animated video emoticon, the animated video emoticon associated with a set of features within a video stream;
detecting a location of at least one feature in the set of features in a frame of the video stream;
tracking a change in location of the at least one feature across another frame of the video stream; and
altering at least one aspect of the at least one tracked feature in the other frame of the video stream.

15. The computer-readable storage medium of claim 14, wherein altering includes removing the at least one tracked feature from the other frame and inserting a computer generated graphics content into the other frame at the location of the removed at least one tracked feature.

16. The computer-readable storage medium of claim 14, wherein the animated video emoticon is selected by a user from a menu of animated video emoticons.

17. The computer-readable storage medium of claim 14, wherein the at least one feature is occluded in the other frame, and wherein detecting the location of the occluded at least one feature is based on a detected location of another feature that is visible in the other frame and a relative position of the at least one feature to the other feature.

18. The computer-readable storage medium of claim 14, wherein the set of features include a middle finger, a thumb, a palm, or a wrist.

19. The computer-readable storage medium of claim 14, wherein tracking further comprises determining an orientation of the set of features based on the detected locations of the at least three features in the set of features.

20. The computer-readable storage medium of claim 14, wherein tracking further comprises detecting the location of a feature that is occluded in the frame of the video but visible in the other frame of the video stream.
